(19) United States
(12) Patent Application Publication
(10) Pub. No.: US 2013/0219006 A1
(43) Pub. Date: Aug. 22, 2013

(54) MULTIPLE MEDIA DEVICES THROUGH A GATEWAY SERVER OR SERVICES TO ACCESS CLOUD COMPUTING SERVICE STORAGE

(71) Applicant: Jenke Wu Kuo, San Diego, CA (US)

(72) Inventor: Jenke Wu Kuo, San Diego, CA (US)

(73) Assignee: Sony Corporation

(21) Appl. No.: 13/401,708

(22) Filed: Feb. 21, 2012

(51) Int. Cl. G06F 15/167

(52) U.S. Cl. 709/213

(57) ABSTRACT

A system, method, and computer program product are provided for enabling client devices to transparently access cloud computing services, service storage, and related data via a gateway server that connects to an external network such as the internet or a social network. Data requests are transmitted from at least one client device to the gateway server. The gateway server determines if the data request cannot be satisfied by data stored in its memory, and responsively transmits a second data request to the external network and stores data received in response to the second data request in its memory. The gateway server then satisfies the data request using the stored data, which may include a web computing service, an application program interface, streaming data, metadata, and/or media data.

### CROSS-REFERENCE TO RELATED APPLICATIONS

The present patent document is related to commonly-assigned patent application U.S. Ser. No. 13/291,075 filed on Nov. 7, 2011, and entitled “SONY EPG METADATA SOLUTION WITH MULTIPLE SERVICE SOURCES”, which is hereby incorporated by reference in its entirety.

### FIELD OF THE INVENTION

The present patent document relates in general to web services, and more specifically to a gateway server for providing registered client devices with services, application program interfaces, and related data from an external network, such as the internet.

### BACKGROUND OF THE INVENTION

Home networking capability is rapidly becoming a must-have feature on today's consumer electronics (CE) products. The addition of internet access to consumer electronics products provides new opportunities to improve and enhance their existing capabilities.

Cloud-based computing is the delivery of computing as a service rather than a product. Shared resources, software, and information are provided to computers and other client devices over an external network “cloud” (with the external network typically being the internet). Cloud-based computing services are more plentiful than ever following recent internet development trends, and consumer electronics media devices for example access such network-based computing services frequently.

Unfortunately, the cost, latency, and complexity of providing computing services from an external network to client devices individually can become prohibitive. This patent application provides a viable approach to solving this challenge and presents a practical implementation of that technique.

### SUMMARY OF THE EMBODIMENTS

A system, method, and computer program product for enabling client devices to access cloud computing services, service storage, and related data via a gateway server attached to an external network are disclosed and claimed herein. An exemplary computer-implemented method embodiment may comprise transmitting a data request from client devices to a gateway server connected to an external network, if the data request cannot be satisfied by data stored in a gateway server memory, selectively transmitting a second data request from the gateway server to the external network and storing data received in response to the second data request in the gateway server memory, and satisfying the data request using the data stored in the gateway server memory.

The client device may comprise a smartphone, a television, a personal computer, a laptop computer, a tablet computer, a personal digital assistant, a video game, and/or a media device. The stored data may comprise a computing service, an application program interface, streaming data, metadata, and/or media data. The data may comprise file formats including HTML5, Java, and/or JSON. The client device and the gateway server may communicate securely, and may communicate via a local area network. The external network may comprise the internet and/or a social network.

Satisfying the data request may comprise filtering data, transcoding data from at least one application program interface, transferring data from the client device to the external network, transferring data from the client device to a second client device, and/or merging data. Data stored in the gateway server memory for the data request satisfies a simultaneous data request and/or a subsequent data request. The gateway server may comprise an http server, and may satisfy the data request transparently to the client device.

The gateway server may satisfy the data request by providing a local computing service comprising receiving data from a client device, tuning, IP streaming, performing DVR functions, providing electronic program guide data, managing security, performing content protection functions, and/or establishing communications between client devices. The method may operate in substantially real-time.

A system embodiment may comprise a processor and a memory containing instructions that, when executed by the processor cause the processor to transmit a data request from at least one client device to a gateway server connected to an external network, if the data request cannot be satisfied by data stored in a gateway server memory, selectively transmit a second data request from the gateway server to the external network and store data received in response to the second data request in the gateway server memory, and satisfy the data request using the data stored in the gateway server memory.

A computer program product embodiment may comprise a computer readable medium tangibly embodying non-transitory computer-executable program instructions thereon that, when executed, cause a computing device to transmit a data request from at least one client device to a gateway server connected to an external network, if the data request cannot be satisfied by data stored in a gateway server memory, selectively transmit a second data request from the gateway server to the external network and store data received in response to the second data request in the gateway server memory, and satisfy the data request using the data stored in the gateway server memory.

As described more fully below, the apparatus and processes of the embodiments disclosed enable client devices to access computing services, service storage, and related data via a gateway server that connects to an external network. Further aspects, objects, desirable features, and advantages of the apparatus and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed invention.

### BRIEF DESCRIPTION OF THE DRAWINGS

FIG. 1 depicts a set of registered client devices that communicate with a gateway server connected to an external network, according to an embodiment;

FIG. 2 depicts a flow chart of the gateway server operation, according to an embodiment.

### DETAILED DESCRIPTION OF EXEMPLARY EMBODIMENTS

There are more and more network consumer electronics client devices available on the market these days, such as tablet or laptop computers, smartphones, smart TVs, personal computers, personal digital assistants, video games, and other media devices. Multiple consumer electronics devices in the same location or facility (e.g. a home or office) may access cloud services with various web applications, and rely on accessing various cloud services or internet storage at the same time.

Accessing computing services via the internet may require related fees, and may impact overall performance. The cloud services may take time to execute in various servers for example, or to download or stream the contents to a particular individual consumer electronics client device. In some cases, redundant contents are simultaneously provided to multiple client devices, e.g. multiple consumer electronics devices may have live-stream downloads of the same IPTV content (such as a Super Bowl program) at the same time.

As an alternative to individual consumer electronics devices accessing dedicated cloud services directly, a centralized gateway server may transparently download, cache, and locally share service contents among securely communicating consumer electronics devices. The gateway server may locally engage various internet services for connected client devices concurrently, and it may store the service contents in its memory, either temporarily or permanently. The gateway server may also enhance the capability of internet service access, or provide the methodology to control and manage the service contents among connected media devices. Caching and sharing content locally among media devices through such a centralized gateway server is more manageable, convenient, faster, and cost-saving.

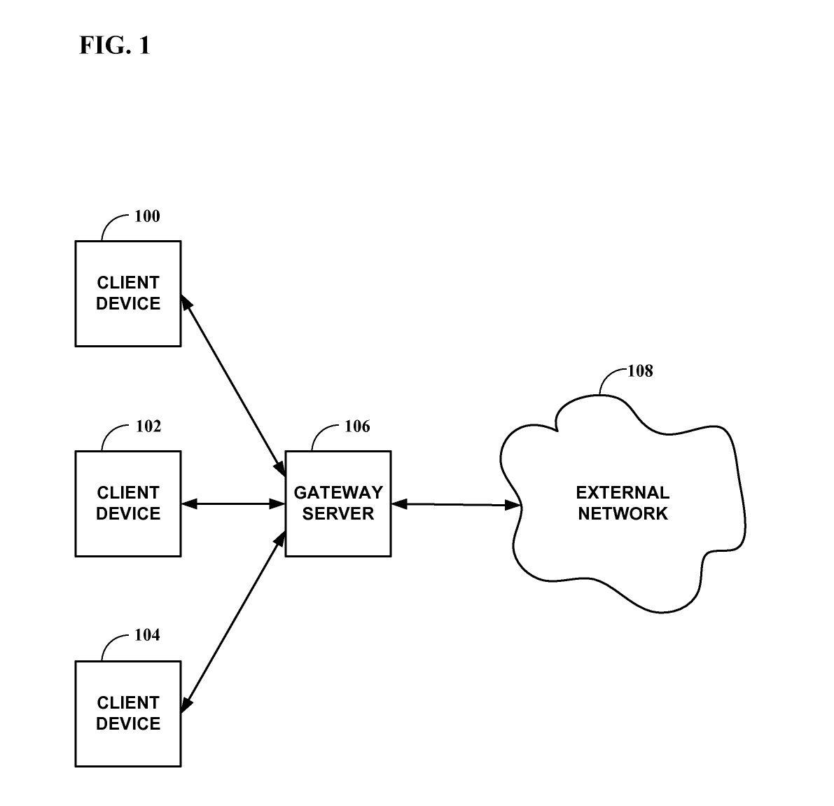

Referring now to FIG. 1, a set of client devices that communicate with a gateway server connected to an external network is shown, according to an embodiment. Client devices 100, 102, and 104 may comprise different consumer electronics devices as previously described. Each is preferably registered with and communicates securely with gateway server 106 internally over a network, which may be a local area network (or LAN). The client devices may share a common user interface.

Gateway server 106 is based on the familiar client and server concept. The gateway server may be assigned with any connected client device dynamically by network protocol. Or, a dedicated client device may be configured to interact with the gateway server locally, to manage the activities of connected client devices both online and offline.

Gateway server 106 also communicates with external network 108, which may for example be the internet and/or a social network. Gateway server 106 may be an http server, and preferably operates in substantially real-time.

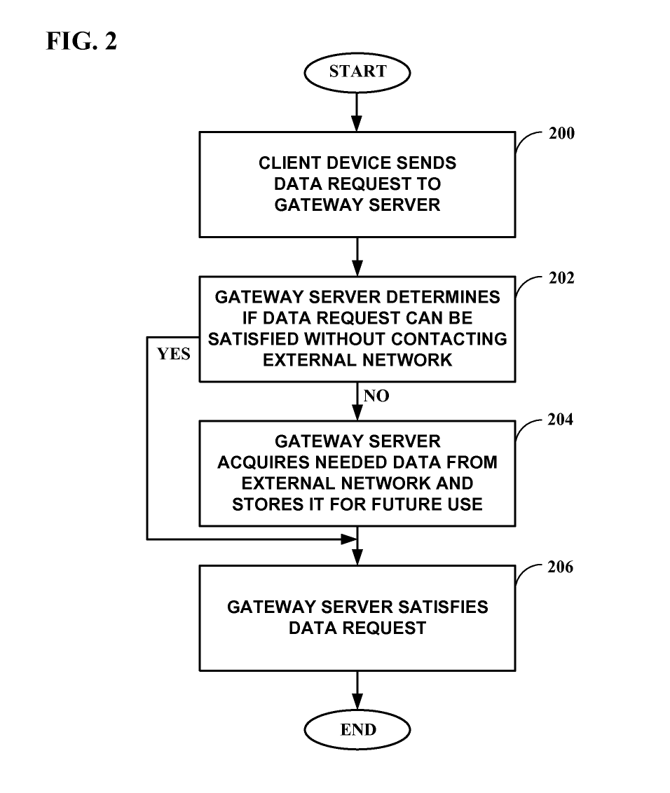

Referring now to FIG. 2, a flow chart of the gateway server operation is shown, according to an embodiment. A client device may send a request for application services to the gateway server through a local network or an internet connection, in step 200. The gateway server may then save the requests into a queue. The gateway server includes a memory that it searches for data needed to satisfy the data request. In step 202, the gateway server determines if the data request can be satisfied without contacting the external network, that is, using only the data it already has in storage.

If the data needed to satisfy the data request is not found in the memory, the gateway server in step 204 responsively acquires the needed data from the external network, and stores it in the memory for future use. Once in memory, the data is available for processing by the gateway server to satisfy the data request. The step of fetching the data from the external network is not necessary if the data is already in memory, which increases efficiency.

In step 206, the gateway server satisfies the data request independently, even if the requesting client device is not connected at the time. The gateway server may be given a script of things to fetch from the external network, and then later provides the fetched material to the client devices, so a slow external network connection is not a major limitation. The gateway server may also merge fetched data and return the merged data to the client device. Additional fetch requests may continue until the client device is satisfied.

The gateway server may download and record streaming data and other media data, application program interfaces (APIs), metadata, and computing services for the client device. The gateway server's operation may itself be governed by a web service. Later, the gateway server may provide the status of the process, and enable access to the cached stream or data as client devices connect. The gateway server may also fulfill the data request transparently to the client device by transcoding data from at least one application program interface. So, the gateway server provides a private cloud service and media management tool.

The gateway server may also serve as the control mechanism for the internal network for security and application management, to enable access to these cloud services by connected consumer electronics client devices. The gateway server may provide its own local services (e.g. tuning, IP streaming, DVR functionality, EPG/metadata management, etc.) among registered devices internally or externally, similar to the concept of a private home media console.

Further, the gateway server may cache the cloud service APIs and related data when it passes the request from a connected device to the internet service. The gateway server may then provide the same cloud service, which has been stored in memory, to other requests of registered devices transparently without accessing the same cloud service again via the internet. The caching time of services and data in the gateway server may be configured by user. This mechanism improves the performance of accessing cloud services dramatically in comparison to having each individual device the access the same service repeatedly through the internet, either simultaneously or subsequently.

The gateway server may also monitor, control, and filter the services of each connected device. The gateway server may act as a gate keeper to perform security checks, filter spam and manage content protection before granting local devices access. In some cases, it reduces the total cost of the service, as only one fee-based connection to the external network (through the gateway server) is required.

The gateway server also enables a user to setup his or her own cloud service in the gateway server platform through internet or social network connections. A user may implement his or her own personal services among client devices on the cloud gateway sever. These personal cloud services may be shared among client devices internally through a local area network or shared with others through internet access.

A user may for example setup and record the broadcast streams, download internet contents, or upload personal video in the local gateway server. Later, any registered devices that connect to the gateway server may play the recorded contents at any time without internet service involvement. The broadcast contents may be recorded and stored as cloud services to share among media devices through an internet connection as well. Users may also upload a customized service or portable applications to the gateway server as a cloud service through the internet, and share it through web sites or with social networks.

The gateway server also locally provides bridge functionality to share media data and remote applications (e.g. a remote user interface, or second display) through an http interface protocol among connected devices. This methodology also provides the server mechanism among connected media devices, to share the contents of remote user interfaces and interaction of portable applications. Using the web application implementation, the portable remote user interface code or platform independent applications (i.e. HTML5, JAVA, JSON, etc.) may be downloaded or executed on multiple media devices through the http protocol.

To recap, the embodiments provide a gateway server that can cache cloud service APIs, responses, and data transferred between a client device on an internal network and a service, and allow multiple client devices to access the same content offline virtually. The gateway server provides the same service which has been stored in memory to other requests of registered devices transparently, without accessing the same service again through an external network. The gateway server provides its own local services among registered devices internally or externally. It also monitors, controls, and filters the services provided to a client device. The gateway server further shares user-made personal services among the client devices, either internally or through the external network. It may handle network security, content protection, spam filtering, and may reduce fees for network access. The gateway server enables a user to set up (capture and share) their own services, for example home security applications such as burglar alarm management. It also enables client devices to share cached material, including services, applications, APIs, and related data, including for example streaming content. The user may establish his or her own network by registering various client devices with the gateway server.

By providing a common gateway server to connect consumer electronics products, the embodiments simplify the process of developing world-wide products, and create opportunities for future business concepts around electronic web services. The embodiments support combining and filtering multiple sources of web services, streaming data, and metadata. Services may be enhanced without impacting existing client products or devices. The embodiments also allow client device software development to be decoupled from the gateway server. By using a cloud service approach, the client device software needs to support only a single source of data, while the gateway server handles data translation. This allows the flexibility to switch from one web service to another while maintaining the same look and feel for the customer, with no changes to the client applications.

With the development of this gateway server, users may create new business opportunities to develop new data services with consumer electronics devices, and enhance existing features with web services. The embodiments provide a common and centralized service gateway to leverage a unified interface to connect consumer electronics devices with user internal services and external internet services for future business opportunities.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The non-transitory code segments may be stored in a processor readable medium or computer readable medium, which may include any medium that may store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, etc. User input may include any combination of a keyboard, mouse, touch screen, voice command input, etc. User input may similarly be used to direct a browser application executing on a user's computing device to one or more network resources, such as web pages, from which computing resources may be accessed.

While the invention has been described in connection with specific examples and various embodiments, it should be readily understood by those skilled in the art that many modifications and adaptations of the embodiments described herein are possible without departure from the spirit and scope of the invention as claimed hereinafter. Thus, it is to be clearly understood that this application is made only by way of example and not as a limitation on the scope of the invention claimed below. The description is intended to cover any variations, uses or adaptation of the invention following, in general, the principles of the invention, and including such departures from the present disclosure as come within the known and customary practice within the art to which the invention pertains.

What is claimed is:

1. A computer-implemented method for providing data to a client device, comprising:
transmitting a data request from at least one client device to a gateway server connected to an external network;
if the data request cannot be satisfied by data stored in a gateway server memory, selectively transmitting a second data request from the gateway server to the external network and storing data received in response to the second data request in the gateway server memory; and
satisfying the data request using the data stored in the gateway server memory.

2. The method of claim 1 wherein the client device comprises at least one of a smartphone, a television, a personal computer, a laptop computer, a tablet computer, a personal digital assistant, a video game, and a media device.

3. The method of claim 1, wherein the stored data comprises at least one of a computing service, an application program interface, streaming data, metadata, and media data.

4. The method of claim 1, wherein the data comprises file formats including at least one of HTML5, Java, and JSON.

5. The method of claim 1, wherein the client device and the gateway server communicate securely.

6. The method of claim 1, wherein the client device and the gateway server communicate via a local area network.

7. The method of claim 1, wherein the external network is at least one of the internet and a social network.

8. The method of claim 1, wherein satisfying the data request comprises at least one of filtering data, transcoding data from at least one application program interface, transferring data from the client device to the external network, transferring data from the client device to a second client device, and merging data.

9. The method of claim 1, wherein data stored in the gateway server memory for the data request satisfies at least one of a simultaneous data request and a subsequent data request.

10. The method of claim 1, wherein the gateway server comprises an http server.

11. The method of claim 1, wherein the gateway server satisfies the data request transparently to the client device.

12. The method of claim 1, wherein the gateway server satisfies the data request by providing a local computing service comprising at least one of receiving data from a client device, tuning, IP streaming, performing DVR functions, providing electronic program guide data, managing security, performing content protection functions, and establishing communications between client devices.

13. The method of claim 1, wherein the method operates in substantially real-time.

14. A system for providing data to a client device, comprising:
a processor; and
a memory containing instructions that, when executed by the processor cause the processor to:
transmit a data request from at least one client device to a gateway server connected to an external network;
if the data request cannot be satisfied by data stored in a gateway server memory, selectively transmit a second data request from the gateway server to the external network and store data received in response to the second data request in the gateway server memory; and
satisfy the data request using the data stored in the gateway server memory.

15. The system of claim 14, wherein the stored data comprises at least one of a computing service, an application program interface, streaming data, metadata, and media data.

16. The system of claim 14, wherein the client device and the gateway server communicate securely via a local area network and wherein the external network is at least one of the internet and a social network.

17. The system of claim 14, wherein satisfying the data request comprises at least one of filtering data, transcoding data from at least one application program interface, transferring data from the client device to the external network, transferring data from the client device to a second client device, and merging data.

18. The system of claim 14, wherein the gateway server satisfies the data request by providing a local computing service comprising at least one of receiving data from a client device, tuning, IP streaming, performing DVR functions, providing electronic program guide data, managing security, performing content protection functions, and establishing communications between client devices.

19. A computer program product for providing data to a client device, comprising a non-transitory computer readable medium tangibly embodying non-transitory computer-executable program instructions thereon that, when executed, cause a computing device to:
transmit a data request from at least one client device to a gateway server connected to an external network;
if the data request cannot be satisfied by data stored in a gateway server memory, selectively transmit a second data request from the gateway server to the external network and store data received in response to the second data request in the gateway server memory; and
satisfy the data request using the data stored in the gateway server memory.

20. A system for providing data to a client device, comprising:
means for transmitting a data request from at least one client device to a gateway server connected to an external network;
means for, if the data request cannot be satisfied by data stored in a gateway server memory, selectively transmitting a second data request from the gateway server to the external network and storing data received in response to the second data request in the gateway server memory; and
means for satisfying the data request using the data stored in the gateway server memory.
